(19) United States
(12) Patent Application Publication
(10) Pub. No.: US 2011/0131852 A1
(43) Pub. Date: Jun. 9, 2011

(54) Exterior clamp triangular slipbase mounting system for roadway sign posts

(76) Inventor: Loren Brian Nelson, Ralls, TX (US)

(21) Appl. No.: 12/592,957

(22) Filed: Dec. 7, 2009

(51) Int. Cl. G09F 15/00; E21D 20/00

(52) U.S. Cl. 40/607.12; 405/259.5

(57) ABSTRACT

A triangular base, sign post mounting system comprising of a slightly tapered inside bore in the shape of a round sign post which bore is created by attaching two rounded halves created from mild steel to a triangular base in such a way that the rounded inside of the two halves are facing each other so as to create a rounded and slightly tapered inside bore and so that the two halves are separated from one another on opposite sides of the inside bore by two narrow adjustment gaps running parallel with the bore. The system has four heavy duty lugs welded onto the outside of the formed halves at a point near the top of the formed halves and positioned so that there are two pairs of lugs facing across from each other through which two exterior clamping bolts can be inserted to securely fasten a sign post to the system. The exterior clamping method and tapered design of the inside bore creates complete surface area contact between the mounting system and the sign post resulting in a vice-like grip containing no slack which prevents the mounted sign post from rotating, rocking, or otherwise coming loose in the mounting system.

### CROSS REFERENCES TO RELATED APPLICATIONS

Not Applicable

### STATEMENT REGARDING FEDERALLY SPONSORED RESEARCH OR DEVELOPMENT

Not Applicable

### REFERENCE TO MATERIALS ON COMPACT DISC

Not Applicable

### BACKGROUND OF THE INVENTION

The present invention relates to the mounting and installation of roadway sign posts onto triangular mounting systems. Several states and jurisdictions use triangular mounting anchors for the installation of sign posts. The triangular shape allows sign posts to be mounted in such a way that the sign post will break away easily when struck by a vehicle thereby reducing the risk of injury to motorists involved in this type of accident. Applicant has been involved with the installation and manufacture of roadway sign posts for a number of years. Through the course of such involvement, Applicant became aware of problems with the mounting systems currently used for the installation of sign posts onto the triangular mounting anchors. In particular, Applicant observed problems relating to the routine failure of current mounting systems to prevent sign posts from rotating, coming loose or sustaining damage after mounting.

Applicant believes the aforementioned problems with current sign post mounting systems are caused primarily by the inclusion in existing mounting systems of either set screws or locking rings to try to hold the sign post in place once it has been secured into the mounting system. When set screws are used, the only direct contact points between the mounting system and the sign post are the points where the set screws touch the sign post. Such contact is inadequate to hold the sign post in pace and ultimately causes the sign post to rotate or become loose after mounting. Additionally, the set screws can damage the structural integrity of the sign post by creating indentations at the point of contact which can lead to premature failure. When a locking ring device is used, sign posts cannot be tightened strongly enough to prevent the sign post from ultimately rotating or becoming loose within the ring. Additionally, the locking ring itself can turn within the system.

The present invention is designed to correct the problems generated by the use of set screws or locking rings commonly found on current models of triangular slipbase mounting systems. Rather than using set screws or a locking ring, the present invention uses a clamping system with exterior bolts to hold the sign post in place within a tapered bore. The exterior bolts and tapered bore create an extremely tight, full surface, clamp on the sign post which prevents the sign post from rotating or becoming loose without causing indentations and premature failure of the sign post.

### BRIEF SUMMARY OF INVENTION

The present invention is a heavy duty triangular slipbase mounting system for roadway sign posts. The invention is attached to a triangular shaped anchor that is secured to the ground through concrete or other means. Once attached to the anchor, the invention serves as the base into which a sign post can be installed. The invention is then responsible for holding the sign post securely in place so that the mounted sign post will not turn or rock in place. Rather than using set screws or locking rings to hold the sign post in place, the mounting system contained in the present invention possesses a slightly tapered inside bore and uses a clamp with exterior bolts as the primary means of holding the sign post in place in the bore. The clamp is tightened around the sign post by the use of two exterior bolts. The clamp and exterior bolt method of securing the sign post, along with the slightly tapered inside bore, allows for complete surface area contact between the mounting system and the sign post which creates a strong, vice-like grip on the sign post. This eliminates the development of slack that ultimately allows the sign post to rotate or become loose as occurs in the mounting systems currently being used. Additionally, because the exterior clamping bolts do not come into contact with the sign post, there is no damage to the structural integrity of the sign post such as that which commonly occurs when set screws are used in the mounting systems.

The present invention is made with all mild steel rather than ductile castings which reduces the chance for breakage. The invention can also be used as a triangular ground anchor without any modification. This is accomplished by attaching a stub to the system in the same manner as a sign post and then inverting the system so the stub can be inserted into the ground. Once the stub is secured into the ground, an additional unit can then be attached to the anchor and used as the sign post mounting system.

### BRIEF DESCRIPTION OF THE DRAWINGS

There are four drawings submitted with the application:

Figure One is a side view of the invention in an exploded view showing how all the parts should be assembled.

Figure Two is a top view of the invention showing the clamping bolts.

Figure Three is an exploded side view of the invention being used both as a mounting system and ground anchor.

Figure Four is a side view of the invention showing a completely assembled unit when in use as both a mounting system and ground anchor.

### DETAILED DESCRIPTION OF THE INVENTION

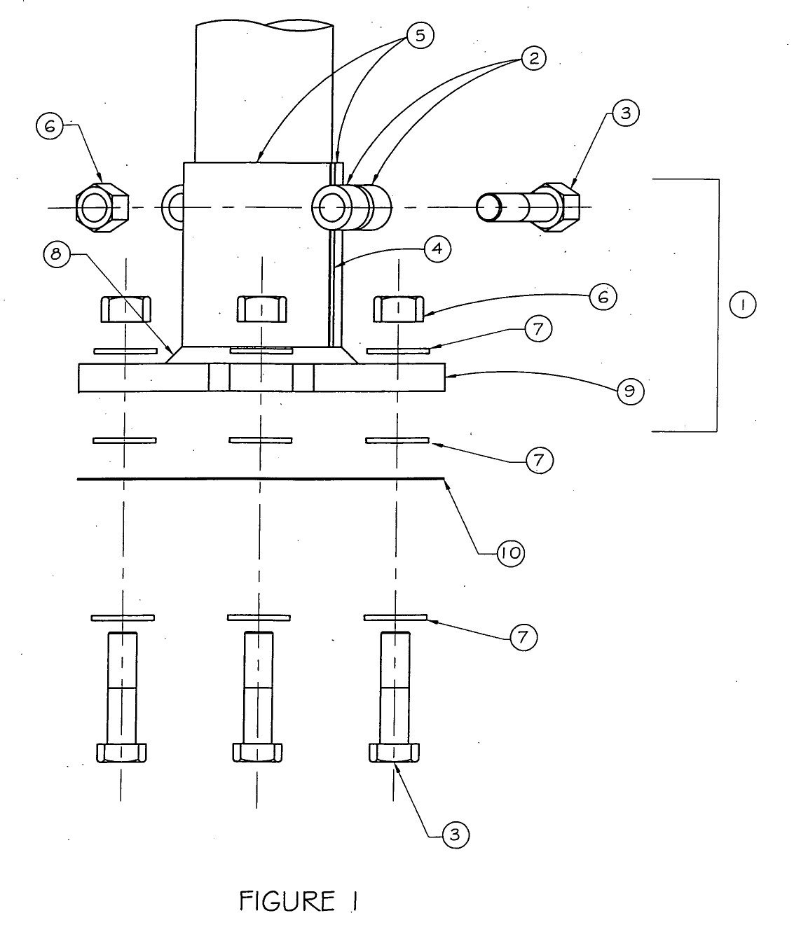

The invention is comprised of two formed, rounded halves fabricated from mild steel which, when attached to a triangular base, are set in such a manner that they create a round and slightly tapered inside bore that is approximately four and one half inches (4½″) long. (See FIG. 1, number 5). The two formed halves, at the point they come together on opposite sides of the inside bore, leave a space for two adjustment gaps which are located on opposite sides of each other and which run parallel with the length of the pipe. (See FIG. 1, number 4). Each adjustment gap is one quarter inch (¼″) wide. (See FIG. 1, number 4).

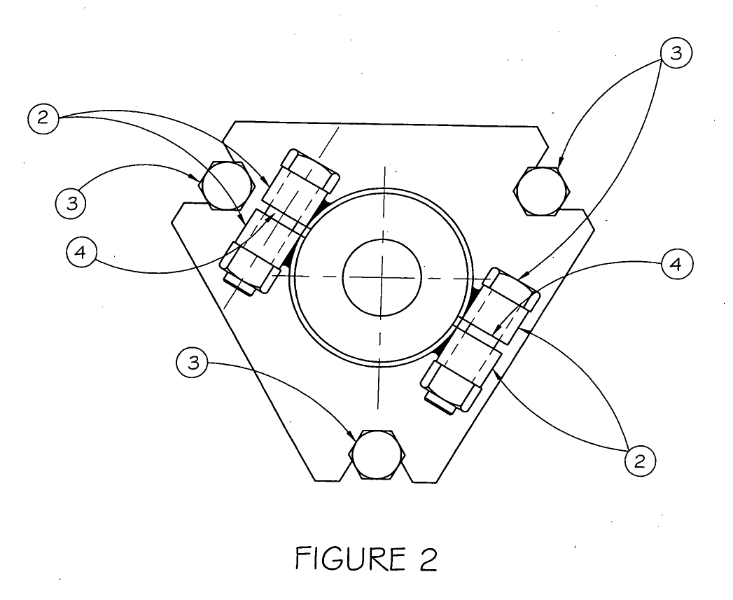

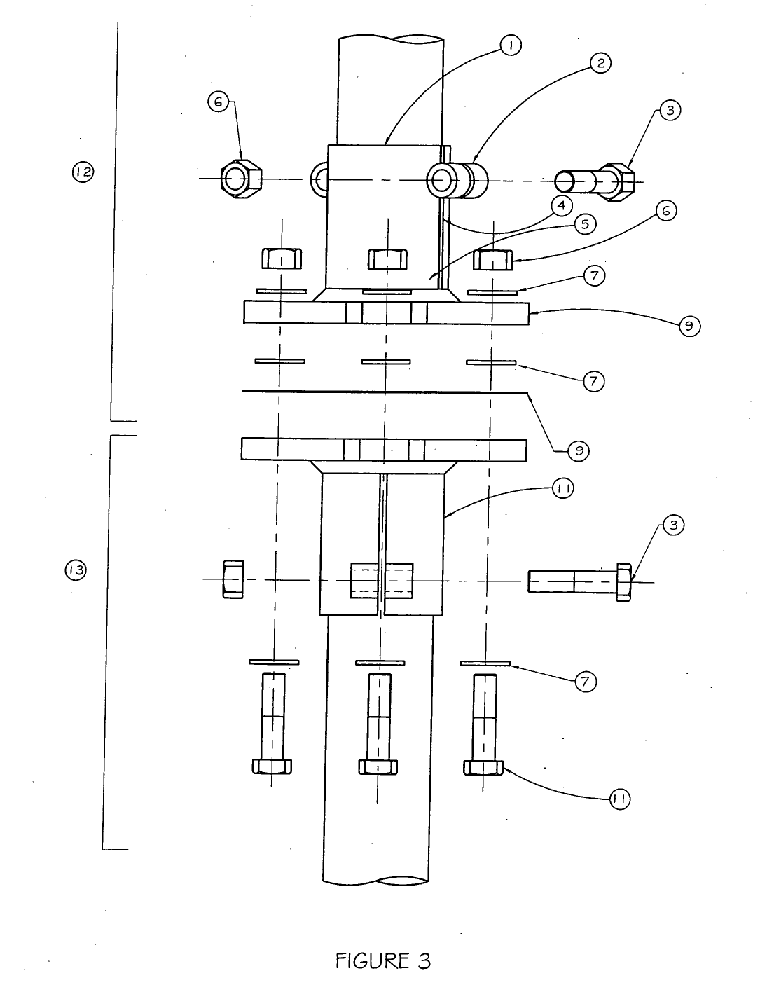

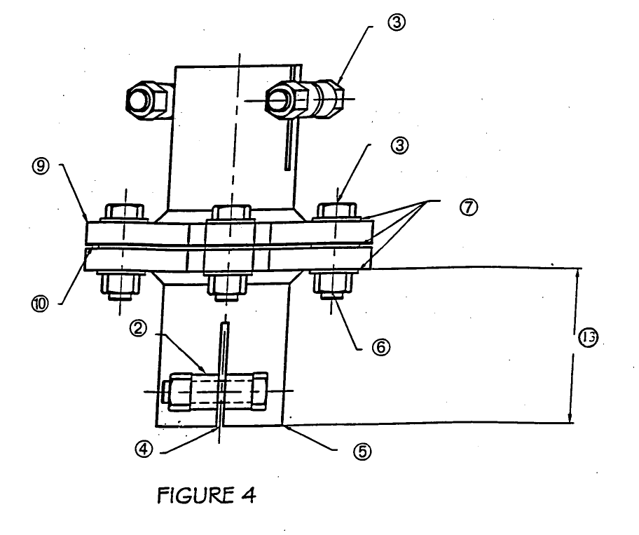

Four lugs are welded onto the formed halves at the top of the adjustment gaps. (See FIG. 2, number 2). Each lug is made up of one inch (1″) hot rolled steel with a twenty-one thirty second inch ( 21/32″) hole bored through the center. Each lug is placed on the formed halves so that the top of the lug is near the top of the formed half. (See FIG. 1, number 2). The lugs are then attached to the formed halves in two pairs with each pair being placed along the two adjustment gaps. The paired lugs are placed opposite one another on either side of the adjustment gap. (See FIG. 2, number 2). The lugs are placed along the adjustment gaps in such a way that the bore of each lug faces the other lug. (See FIG. 2, number 2). The lugs are positioned so that when a bolt is inserted through a pair of lugs, the bolt will run perpendicular to the direction of the adjustment gaps. (See FIG. 2, number 3). The use of the lugs on the exterior of the two formed halves, along with the slightly tapered inside bore, creates a heavy duty exterior clamping system that is specially suited for mounting highway sign posts because the system allows for an extremely strong grip along the entire length of sign post within the inside bore. Once complete, the system comprises a triangular slipbase sign post mounting system that can then be easily attached to a triangular shaped, breakaway anchor by the use of three mounting bolts. After the system is attached to the base anchor, a sign post can be mounted by tightening the bolts through the two pairs of lugs.

### EXPLANATION OF REFERENCE NUMBERS FOR DRAWINGS

| REFERENCE | |
|---|---|
| NUMBER | DESCRIPTION/PART NAME |
| 1 | Exterior Clamp Triangular |
| | Slip Base Mounting System |
| 2 | Lug |
| 3 | ⅝ × 2½ A325 Bolt |
| 4 | Adjustment Gap |
| 5 | Formed Halves |
| 6 | ⅝ × 2 H Nut |
| 7 | Hot dipped galvanized |
| | ⅝ × ASTM F436 washer |
| 8 | Weld |
| 9 | ⅝″ triangular plate |
| 10 | Bolt Keeper 26 ga. |
| | Galvanized sheet steel |
| 11 | Ground Anchor |
| 12 | Invention used as mounting system |
| 13 | Invention used as Ground Anchor |

1. A sign post mounting system comprising of a slightly tapered inside bore in the shape of a round sign post which bore is created by attaching two rounded halves created from mild steel to a triangular base with the rounded inside of the two halves facing each other and with the two halves being separated on opposite sides of the inside bore by two narrow adjustment gaps running parallel with the bore, and which system contains four heavy duty lugs welded onto the formed halves at a point near the top of the formed halves and positioned so that there are two pairs of lugs facing across from each other through which two exterior clamping bolts can be inserted to securely fasten a sign post that has been placed in the tapered inside bore, thereby allowing complete surface area contact between the mounting system and the sign post resulting in a vice-like grip containing no slack which prevents the mounted sign post from rotating, rocking, or otherwise coming loose in the mounting system.

2. The mounting system of claim 1 further defined by the use of a clamp with exterior clamping bolts and heavy duty lugs so as to avoid deformation and damage to the sign post by allowing a smooth contact between the sign post and the mounting system.

3. The mounting system of claim 1 further defined by the use of a clamp with exterior clamping bolts and heavy duty lugs so as to eliminates any direct contact between the clamping bolts and the sign post thereby preventing the bolts from causing any damage to the structural integrity of the sign post.

4. The mounting system of claim 1 further comprising an inside bore in the mounting system which inside bore is slightly tapered at the bottom which means there is complete and direct surface contact between the mounting system and the sign post for the entire length of the inside bore which allows the mounting system to have a stronger grip on the sign post and which allow for easy insertion of the sign post into the mounting system.

5. The mounting system of claim 1 further defined by its design which allows for the easy installation of a sign post into the mounting system because the sign post can be placed and secured into the mounting system after said mounting system has already been attached to a ground anchor, thereby allowing for an installation process that is significantly faster than existing methods of mounting sign posts.

6. The mounting system of claim 1 further defined by the use of all mild steel rather than ductile or cast iron which greatly reduces the risk of failure because of the flexibility of the mild steel.

7. The mounting system of claim 1 further defined by the use of five nuts and bolts, all of the nuts and bolts being of one size, such that installation can be accomplished with only two wrenches or socket devices.

8. The mounting system of claim 1 further defined by its ability to be used as an effective ground anchor without any modification to the system simply by inverting the system and attaching a stub rather than a sign post, and then securing the stub into the ground by concrete or other means.
